(19) United States
(12) Patent Application Publication
(10) Pub. No.: US 2024/0288249 A1
(43) Pub. Date: Aug. 29, 2024

(54) Mobile System and Method of Protecting from Projectiles

(71) Applicants: Robert Francis Bodi, Westlake, OH (US); John B Adrain, Farmerville, TX (US)

(72) Inventors: Robert Francis Bodi, Westlake, OH (US); John B Adrain, Farmerville, TX (US)

(21) Appl. No.: 18/277,069

(22) PCT Filed: Jan. 14, 2022
(86) PCT No.: PCT/US22/12537

§ 371 Date: Aug. 12, 2023

Related U.S. Application Data
(60) Provisional application No. 63/228,146, filed on Aug. 1, 2021.
(60) Provisional application No. 63/137,318, filed on Jan. 14, 2021.

(51) Int. Cl. F41H 5/013; B32B 5/02; B32B 5/06; B32B 5/26; B32B 7/12; F41H 5/04; F41H 5/24

(52) U.S. Cl. CPC F41H 5/013; B32B 5/024; B32B 5/073; B32B 5/263; B32B 7/12; F41H 5/0471; F41H 5/24; B32B 2250/20; B32B 2262/02; B32B 2307/3065; B32B 2307/54; B32B 2307/558; B32B 2571/02; F41H 5/0407

(57) ABSTRACT

A mobile device including a frame that may be collapsible or retractable and structurally designed to help deploy a deployable anti-ballistic barrier that can be comprised of a laminate of a plurality of layers of material comprising anti-ballistic materials. The mobile device can be stowed in a storage area when not used but moved into an area for deployment of the barrier to protect a space from ballistic projectiles including shrapnel, thrown objects, and bullets.

### CROSS-REFERENCES TO RELATED APPLICATIONS

This application claims the benefit of U.S. Provisional Patent Application Ser. No. 63/137,318 filed on Jan. 14, 2021, and U.S. Provisional Patent Application Ser. No. 63/228,146 filed on Aug. 1, 2021, both incorporated herein by reference. This application incorporates all of the material disclosed in U.S. patent application Ser. No. 17/006,442 filed on Aug. 28, 2020 and its US parent and priority applications; U.S. patent application Ser. No. 16/215,162, and its parent applications; U.S. patent application Ser. No. 15/050,639 filed on Feb. 23, 2016 which is a continuation-in-part of U.S. patent application Ser. No. 14/476,206 filed on Sep. 3, 2014, which claims the benefit of U.S. Provisional Application No. 61/873,073, filed on Sep. 3, 2013, and also claims the benefit of U.S. Provisional Application No. 62/119,510 filed on Feb. 23, 2015, all of which are incorporated herein by reference in their entirety.

### BACKGROUND

This application relates generally to mobile anti-ballistic barriers and anti-vehicle and anti-personnel barriers that can be provided in buildings, vehicles, and other items and locations to add anti-ballistic properties to those items and locations in order to protect a space from a kinetic object that may be of substantial mass.

Conventional approaches for protection against moving objects having substantial kinetic energy, such as vehicles, running personnel, rockets, bullets and/or shrapnel, involve the use of heavy, rigid materials that are fixed in place and provide a barrier based on their rigidity, heft, and strength. However, such items often transmit the energy of the projectiles through the material into the item or location being protected, or because the energy is not properly dissipated, the projectile may still have sufficient energy to penetrate the barrier in a dangerous manner, or because of the heavy weight the barrier cannot be quickly deployed.

Needed is a way to better absorb the kinetic energy of the undesired object to avoid penetration or other transmission of the energy to the item or person or space being protected.

Also needed is a way to provide such protection in a mobile manner so that the protection, using lightweight but strong materials, can be moved to where they are most needed.

### SUMMARY

Provided are a plurality of example embodiments, including, but not limited to, a mobile barrier that is free to flex and move when struck by a kinetic object, said barrier for protecting an interior of a building, vehicle, or an individual.

Also provided is a mobile device configured to protect a space from ballistic objects, comprising: a deployable barrier comprising a flexible anti-ballistic material that can be retracted and deployed; and a deployment structure configured to hold said deployable barrier in the deployed position in conjunction with said storing structure, wherein when in a deployed position, said deployment structure is configured to keep said deployable barrier in the deployed position while engaging ballistic projectiles impinging upon said deployed barrier from outside said space to protect said space, and wherein when said deployable barrier is in a retracted position, said mobile deployable barrier is configured to be mobile.

Further provided is a system for protecting a space from entry by prohibited kinetic objects of substantial mass using a deployable and mobile barrier, comprising: a mobile mounting structure configured for storing the deployable barrier in a retracted position; the deployable barrier comprising a plurality of sheets of flexible anti-ballistic material formed into a laminate; a structure for securing the sides and/or bottom of the deployable barrier to secure said deployable barrier in a deployed position; and a deployment mechanism configured to drop the deployable barrier into the deployed position such that the barrier protects the space from entry by prohibited kinetic objects having substantial kinetic energy.

Also provided is a mobile system for protecting a space from entry by prohibited kinetic objects of substantial mass using a deployable and mobile barrier, comprising: a mobile mounting structure configured for storing the deployable barrier in a retracted position; the deployable barrier comprising a plurality of sheets of flexible anti-ballistic material formed into a laminate, wherein said barrier is configured to flex and move in response to impact from the kinetic object to absorb energy from the kinetic object to further protect said space from access by the ballistic object; a structure for securing the sides and/or bottom of the deployable barrier to secure said deployable barrier in a deployed position; and a deployment mechanism configured to drop the deployable barrier into the deployed position such that the barrier protects the space from entry by prohibited kinetic objects having substantial kinetic energy.

Still further provided is a mobile system for protecting a space from entry by moving vehicles using a deployable barrier, comprising: a mobile mounting structure configured for storing the deployable barrier in a retracted position; the deployable barrier comprising a plurality of sheets of flexible anti-ballistic material formed into a laminate, wherein said barrier is configured to flex and move in response to impact from the moving vehicle to absorb energy from the kinetic object to further protect said space from access by the ballistic object; a structure for securing the sides and/or bottom of the deployable barrier to secure said deployable barrier in a deployed position; and a deployment mechanism configured to drop the deployable barrier into the deployed position such that the barrier protects the space from entry by moving vehicle.

Further provided is a method of protecting a space from ballistic projectiles, said method comprising the step of: providing a mobile device comprising a deployment structure and deployable barrier including a flexible anti-ballistic material that can be retracted and deployed for mobility and storage, wherein said storage structure is configured to hold said deployable barrier in a deployed position in conjunction with said storing structure for protecting said space, such as any of the devices described hereinabove; storing said mobile device in a storage location until needed for deployment; moving said mobile device to said space; and deploying said deployable barrier to protect said space from said ballistic projectiles.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 illustrates an example of a generic anti-ballistic barrier.

FIG. 2 illustrates another example of a generic anti-ballistic barrier.

FIG. 3A illustrates an example laminated structure for an anti-ballistic barrier that provide both decorative and anti-ballistic features;

FIG. 3B illustrates another example of a laminated structure for anti-ballistic barriers that provide a plurality of layers stitched together;

FIG. 3C illustrates another example laminated structure for anti-ballistic barriers that provide a plurality of layers having a hollow interior to allow additional energy dissipation;

FIG. 4 illustrates a first example embodiment of a mobile anti-ballistic barrier system;

FIG. 5 illustrates a second example embodiment of a mobile anti-ballistic barrier system;

FIG. 6 illustrates a third example embodiment of a mobile anti-ballistic barrier system;

FIG. 7 illustrates an example embodiment of the anti-ballistic mobile barrier system similar to FIG. 6 that is temporarily secured in place;

FIG. 8 illustrates an example embodiment of a mobile, deployable barrier system with projector surface;

FIG. 9 illustrates an example control system for the mobile barrier system;

FIG. 10 illustrates an example fence section for another example mobile anti-ballistic barrier system;

FIG. 10A illustrates an example fence using the fence sections of FIG. 10 for providing an anti-ballistic protection perimeter;

FIG. 11 illustrates an example fence constructed from the example fence sections of FIG. 10 protecting a space; and

FIG. 12 illustrates a mobile platform for any of the example mobile systems.

### DETAILED DESCRIPTION OF THE EXAMPLE EMBODIMENTS

There are various proposals for improving ballistic protection of individuals and interior spaces in buildings and vehicles as discussed in the related patent applications listed at the top of this application. The inventor has discovered that a problem with many current solutions to these problems is that the protection devices don't absorb much of the energy that is contained in the ballistic projectiles, such as shrapnel or bullets that have been fired, or objects of relatively large kinetic energy, such as vehicles, rockets, missiles, or running personnel. Also, barriers tend to be fixed to a particular spot, and tend to be bulky and of heavy mass. The inventor has determined that one solution to this problem is to allow the protective device, such as a screen, panel, shroud, blind, or other barrier to be placed in a mobile system, but allowed to hang freely or substantially freely, perhaps in a weighted manner, which allows the barrier to flex, vibrate, flow, sway and otherwise move in response to receiving the projectile, thereby dissipating some of the energy from the projectile that otherwise would remain as kinetic energy. This reduces the amount of damage and potential penetration of the projective with respect to a given amount of projection. Alternatively, the barrier may be secured or securable on a portion of its periphery, such as along sides or a bottom (to avoid pushing aside the barrier), or with a fixed perimeter but sufficient looseness to allow substantial movement, all allowing the main body of the barrier to flex and/or vibrate and/or oscillate to absorb and dissipate kinetic energy.

As shown in U.S. patent application Ser. No. 16/215,162 and its related parents, all incorporated herein by reference, various deployable barriers using non-metallic anti-ballistic materials, such as anti-ballistic cloth laminates, can be formed for use as barriers, such as window blinds and similar barriers that might be provided at various locations in buildings. Use in windows, doorways, hallways, and other interior locations as a deployable barrier that is stowed when not needed provides a way to protect various interior spaces within buildings. Furthermore, barriers can be provided within vehicles in either deployable or fixed manners (or both). Deployable barriers might be used to protect vehicle windows, doorways, hatches, and other access points, whereas permanently deployed barriers could be provided within vehicle voids such as in doors, body panels, and other locations.

Of particular interest are barriers that are lightweight and flexible in nature but that despite being portable and mobile, can absorb a substantial amount of kinetic energy from moving objects of substantial mass. In particular, a mobile system is provided that allows the barrier to be moved to different locations, where it may be fixed in place using anchors, guy wires, weights, latches, or allowed to remain mobile.

In some embodiments, the mobile barriers may hang freely, not being fixed on their sides and bottoms or sides and tops, or tops and bottoms, but that may include weights or other structures to increase their overall effective mass. Such barriers are free to flex and move in response to receiving a ballistic projectile, such as a high velocity bullet or arrow or shell or explosive shrapnel, thereby converting at least a portion of the kinetic energy of the projectile into kinetic and heat energy in the barrier distributed across the entire surface area of the barrier. Lower velocity ballistic projectiles can also be mitigated. Allowing this free motion actually increases the effectiveness of the barrier by reducing the penetration energy of the projectile, thereby effectively improving the ability of the barrier to protect the desired person and/or interior region.

Of additional interest for at least some other embodiments are mobile barriers that are still designed to flex and move in interior portions (centers), but that are fixed on their sides and/or bottoms (i.e., fixed around a perimeter or portion thereof or fixed at one end and weighted at another) in order to add additional stability and strength, such as to prevent a person or large object from entering a protected region. Strong frames can be provided to allow the barriers to be mobile, but stable. Such mobile barriers are still free to flex and move, or oscillate and/or vibrate, in response to receiving a ballistic projectile in at least portion of their surface area, thereby converting at least a portion of the kinetic energy of the projectile into kinetic and heat energy in the barrier distributed across the entire surface area or a substantial portion of the barrier. The fixed sides and/or top and/or bottom prevent individuals or objects from easily bypassing or pushing aside the barrier to get into the protected region, in particular if the mobile barrier is anchored in place once positioned. Hence, it may be that only the perimeter, or a portion of the perimeter, is fixed and secured to a strong frame, whereas an interior portion, and possible one or more sides, of the barrier is free to flex, vibrate, and otherwise kinetically absorb the energy of a ballistic projectile impinging on the barrier.

Finally, of interest are also barriers that are stiff and durable, perhaps using slats that can be retracted into a base portion and/or rotated to allow light through, but that are lightweight by using the lightweight, but strong and durable anti-ballistic materials disclosed herein. Even slats can provide sufficient flexibility and oscillatory movement to help absorb energy. Such barriers can be provided using such materials that provide both anti-ballistic protection, and that can protect spaces from undesirable entry by persons, vehicles, and other objects that might attempt access into the protected spaces. In particular, a barrier that can stop a speeding vehicle or strongly thrown or launched object having substantial kinetic energy is desired. And the ability to stop high velocity objects such as bullets and shrapnel can also be provided.

Furthermore, fiber cables or ropes or twines could be formed using threads or fibers made of any of the disclosed lightweight antiballistic materials, which can be used for strength re-enforcement purposes while maintaining light weights. . . . Such ropes/cables could be used to strengthen any blinds, shutters, doors, or other barriers against penetration from larger objects such as vehicles, people, tools, etc. These materials could also be formed into mesh sheets or nets that could act similarly. In this way, blinds, shutters, doors, or other barriers can be re-enforced in order to strengthen them against larger, slower moving objects, in addition to anti-ballistic protection.

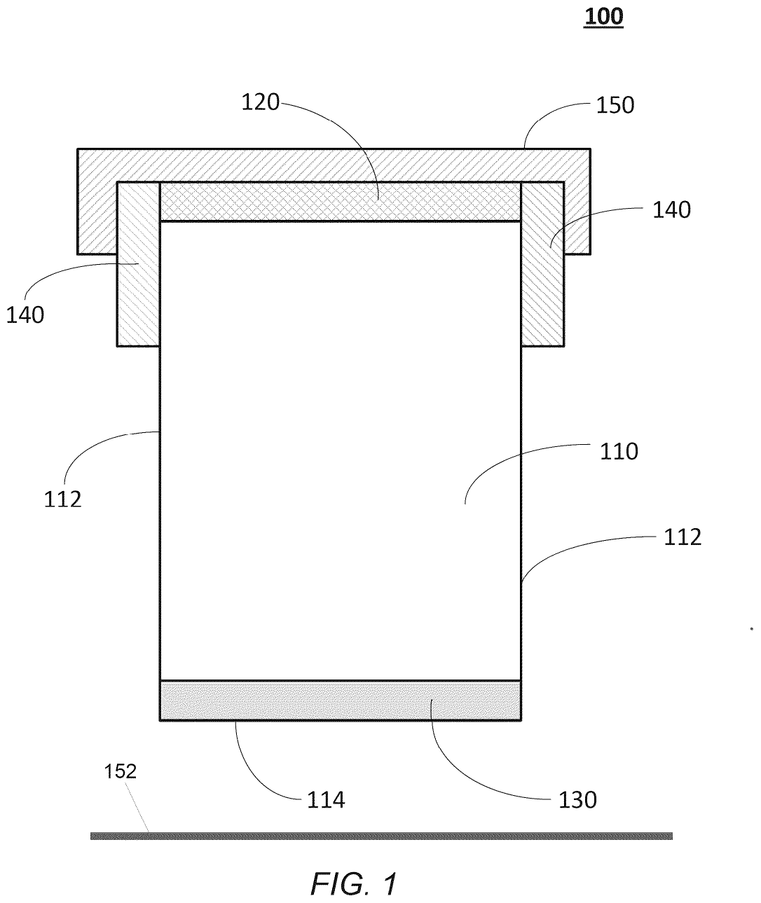

FIG. 1 shows a schematic of a basic fixed or mobile barrier design 10 that can be used for many of these various barriers (components provided to enable mobility are not shown) over a floor or ground 152. The primary protective part is a barrier layer 110 which in many of the example embodiments will be comprised of a laminate of a plurality of layers of flexible antiballistic material. Top frame component 120, side frame components 140, and bottom frame component 130 can be provided to stabilize and secure the barrier layer 110 and any of them might be made retractable (e.g., into a receptacle 150) or removable. Receptacle 150 is provided to receive at least the barrier layer 110 when in a retracted state. A weight can be provided in or on the bottom frame component to stabilize the barrier layer 110 of the mobile barrier 100. The top frame component may include a motor or other deployment device to automatically deploy the barrier layer 110 in emergency situations. Retraction can be manual or automated.

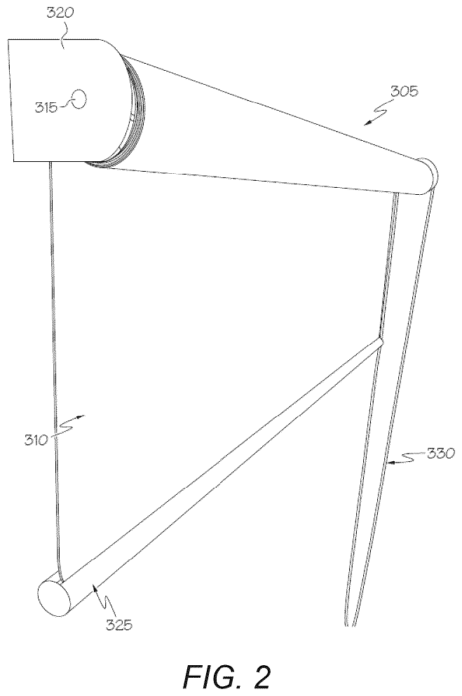

Such a device as 100 of FIG. 1 can be made mobile by fully or mostly retracting the device into the receptacle or some portion of the frame, which might be hanged on a ceiling or wall using configurable hangers. FIG. 2 shows an example of a mobile barrier that has been hung on a wall or in a window frame using brackets 320 connecting to an axel 315, which might be provided in advance. There might be a slot in brackets 320 (not shown) that allow axel 315 so be dropped into place. This mobile barrier also has a barrier layer 310, and is shown with a weight or bottom frame 325 and deployment chain 330.

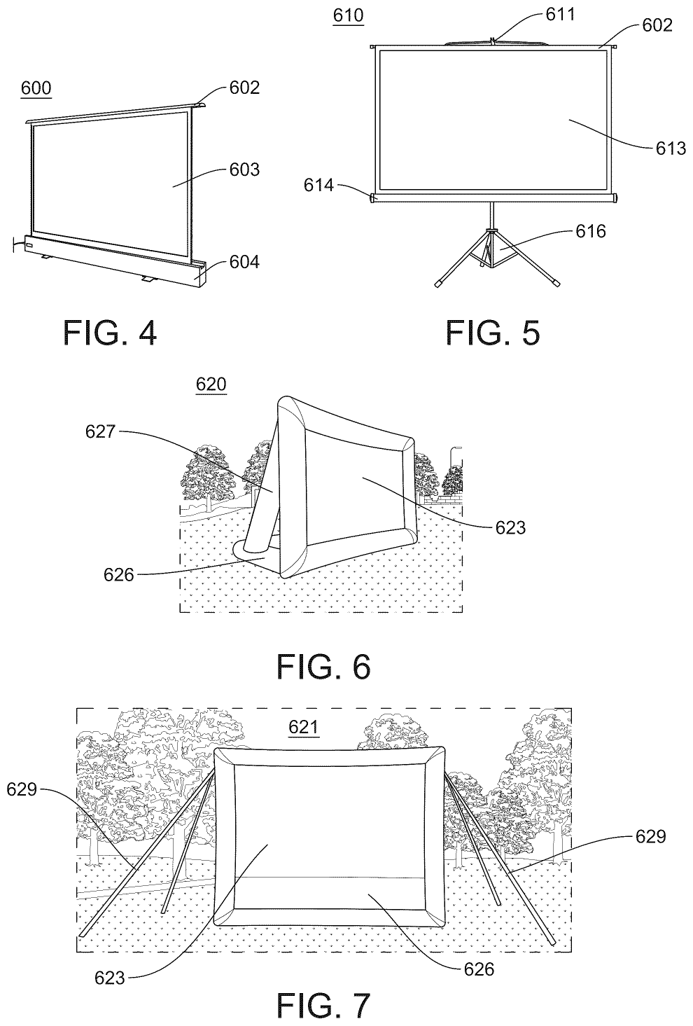

FIG. 4 shows a laminate 400 that can be used to form the barrier layers described above (and below), with an inner layer 420 that is also likely to be a laminate, and with optional outer layers 410 and 430 providing protection and/or decorative layers.

The inner layer 420 can be comprised of a plurality of layers of anti-ballistic material that might include layers of one or more of: plastic, composites, wood, metal, fabric, fiberglass or any other suitable anti-ballistic material including, but not limited to, Kevlar® (which is a synthetic fiber of high tensile strength comprised of poly-para-phenylene terephthalamide) or Lexan® (which is a transparent polycarbonate of high impact strength) or Lucite® (which is a solid transparent plastic comprised of polymethyl methacrylate) or DuPont™ Tensylon® (which is an ultrahigh molecular weight polyethylene anti-ballistic material), or Dyneema® (ultra-high molecular weight polyethylene (UHMwPE)), or a boron treated cloth, or plexiglass with anti-ballistic properties, for example, or any combination thereof. Any type of Ultra High Molecular Weight Polyethylene could be used. Anti-ballistic gel materials such as shear thickening fluids that may be transparent can be used to saturate a material or fill voids (some of these materials harden upon impact and might be comprised of non-Newtonian fluids that that thicken in response to force). Other materials or combinations described elsewhere in this document can also be used as an alternative or supplement these materials. The layers can be comprised of woven cloth of fibers or threads of the anti-ballistic material(s).

Such barriers can have a variety of purposes. For example, these barriers are designed to: (1) Slow down or stop bullets; (2) Stop thrown materials; (3) Stop explosive Blast; (4) Stop Fire, Firewall; (5) Stop a rocket, missile, or other launched or thrown object; (6) Prevent Eavesdropping (possibly by vibration); (7) Block light; (8) Provide sound transmission; (9) provide noise supression, or active noise cancellation; (10) stop individuals or vehicles; and (11) provide a surface to reflect lights that could change colors, or strobe to disorient, or project images; among others.

Also, the barriers can be comprised of various materials: (1) Fabric, i.e. Kevlar®, dyneema®, coated fibers, gels to fill layers for strength, can be used to keep barriers in place etc.; (2) Ceramic/veneer; (3) Gel to dissipate heat or stop bullet; (4) Any hollow cavity can be filled with foam for strength; (5) Various placements of hinges for support and movement; (6) Modular Sections, acoustic panels, electrostatic speakers, flat speakers; and (7)-Shutter with metal, wood, veneer to make attractive and act as strike face (slat can also have thin metal edge for looks); among others.

The barriers can also be provided of various sizes and configurations, such as vertical or horizontal; movable on their axis and turn/spin to displace energy efficiently; and panel sizes can vary on application, e.g., specifically for rolling panels. Barriers sufficiently flexible and thin to be rolled into a roll are particularly desirable.

The barriers can be placed in various locations, including: doorways; windows; hallways, vehicles; personal residences; schools/large buildings in need of security; garage doorways; alleyways; courtyards, parks, playgrounds, loading docks; shipping containers, and any location that needs protection against ballistic projectiles (e.g., bullets, shells, arrows, rockets), or blast shrapnel along with vehicle or personnel barriers.

The frames of the mobile, portable barriers can be retractable or can be disassembled. For example, the frame might be deployed and retracted in a manner such as provided for various portable tents, with individual poles that can be assembled together into a frame. Such a structure can utilize bungie cords or rubber straps, Velcro, etc. to hold the screen barrier to the frame. The frame may be collapsible and the screen retractable in the manner of a portable projector screen. The barrier might comprise a collapsible section of fence that can be combined with other sections to form long, and/or high, sections of fencing to protect large spaces or regions or structures.

The material of the screen could freely suspend, be slightly weighted, or could slide in a track, snaps, Velcro etc. The frame could be telescopic, fold into itself, be disassembled into individual components, etc. The frame unit could have tether points, positions for weights, tanks or bladders that could be filled with water (adding mass) or air. The whole frame could be on locking wheels. That way the water could be drained easily. It would also allow for it to be moved easily.

The unit could also deploy a lightweight roller shutter or venetian blind. The fabric barrier allows you to deploy multiple layers by folding it over one or more times. Additional protection can be added using units/cartridges to the same frame depending on the desired threat level. Hence, the screen can be thickened using multiple layers of protection. Multiple mobile devices could be deployed in a serial fashion to provide additional protection, with earlier barriers slowing projectiles and latter barriers stopping them.

The unit could also slide into mounting hardware that is attached to the floor or inserted into the ground. The floor/ground hardware could be recessed especially in new construction. The shutters or screen could be clear or tinted Lexan so the light would pass but not the bullets. Or louvers could be positioned to let light in but not bullets or blast. By tilting them in an upward or downward direction. The unit could have rechargeable batteries for the operation and the stabilization of the frame.

The portable barrier could also be motorized to automatically deploy where they are needed. They could also communicate with each other or with any external controller or device such as Alexa. With a silica layer added to the layer they could also be deployed to act as a firewall or protect from radiant heat.

Motorized barriers could be deployed to slow down assailants or position themselves in a hallway or doorway. If automated, that could act like a bodyguard. Heavier versions could be used to protect people on a tarmac or open space such as a field or stadium.

A drone version could be provided to hover with a protective shield or skirt. An army of such drones could be synchronized to be deployed very rapidly to act as a cloak. Barriers might be draped between drones to protect larger areas. The devices could be adapted to spray a pepper spray fog or fire in the direction of the enemy.

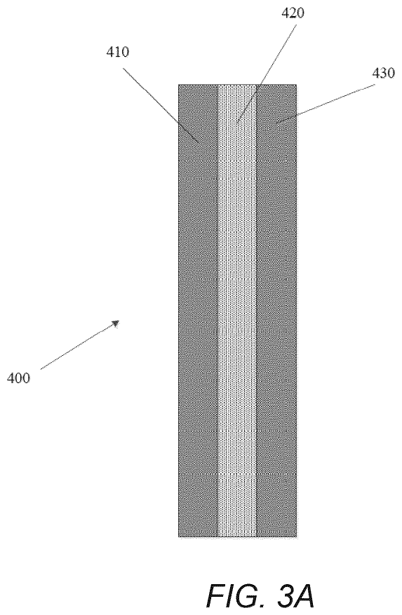

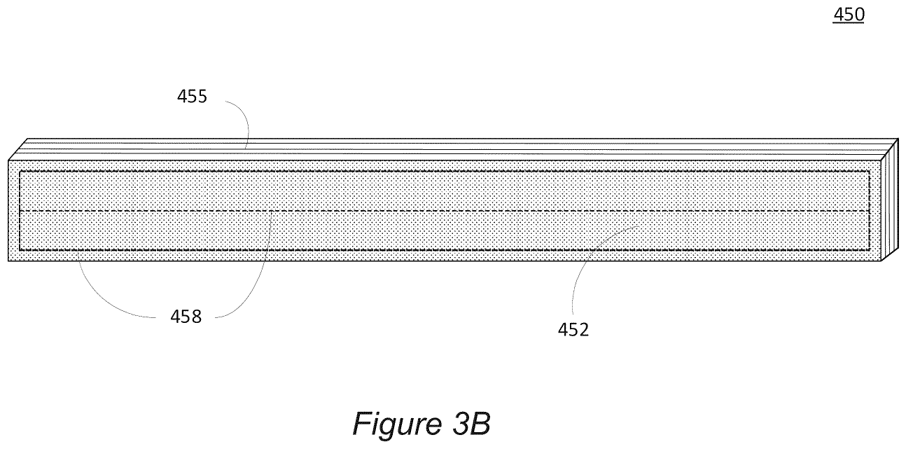

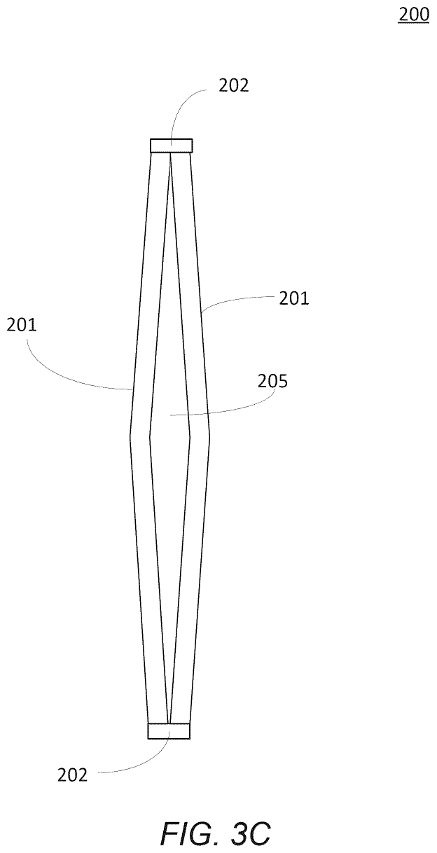

All of the layers provided in the laminate 400 of FIG. 3A (that may be used as the barrier layers described herein) can be secured together using any combination of a number of securing approaches, including the use of glue, heat bonding, stitching, quilting, or other means, or any combination thereof, to secure the various layers of the laminate together. Hence, the laminate can be manufactured using stitch bonder or quilting machines, leading to a multi-layered laminate having a plurality of flexible layers and leading to a flexible laminate. Note that each layer might be comprised of thin, solid sheets of any of anti-ballistic material or the material could be woven into a durable and tough and flexible fabric using threads and/or fibers of the material.

It is desirable to provide a laminate that can be made into long lengths (of many yards, such as dozens or hundreds of yards, for example) of continuous material, with widths of 36, 48, 54, or even 60 inches or more. These wide widths increase the areas that can be covered by the resulting barriers without needing to bond or stitch them together. Longer widths can be formed by stitching, gluing, etc. together.

An aspect of the first surface that a bullet or other projective hits can be designed to act like a strike face, to slowdown and deform/mushroom the projectile before it hits the inside layers which then stop the projectile. For example, the outside layer can be anodized, coated, plated or treated/coated to provide the first task of slowing and deforming the bullet before it hits the layers that do the heavy lifting. The outside strike face can have ridges or protrusions to roll the bullet. There could also be a ceramic veneer or layer to act as the strike face. The strike face layer can also be a combination of different technologies such as to keep the weight down. The whole barrier assembly can be spring loaded or partial break away to dissipate energy, or to move in an X, Y or Z direction. The strike faces could slide in pockets of the barrier. The hinges can be metal or composite based.

A security film can be applied to the strike face to slow down and mushroom the projectile such as a bullet. The material would not be flammable like glass and other methods currently used, would be safer for schools etc. On lightweight metal barriers or blinds (having metal slats) a coating or layer/foam, or lightweight material slides in to the extrusion or stamping.

The barrier shape can be used to change the roll of the bullet, various angles to get bullet on its side, for example. The point of the first, outer layer (other than surface decorative layer(s)) is to act as a strike face and slow down and mushroom flatten out the bullet/projectile. When glass is in front of the barrier, a security film can be applied to a surface of the glass that acts as a strike face to slow down the bullet.

On light weight metal barriers (e.g., shutters or blinds that might use slats) a coating or layer of lightweight material such as Tensylon that fastens or slides into the extrusion or stamping. The barriers could also be a clear Lexan that darkens with sunlight. The barriers or shutters could also be a laminated/sage glass that darkens automatically or when electricity is applied.

Barriers can also be a shutter made of Tensylon that has a metal, ceramic or wood veneer surface, to make that barriers more presentable but also act as a strike face. The slats or edges can also have a metal edge to improve the appearance. Lightweight materials light Dyneema® can act as a ladder or to keep the barriers aligned. A metal shutter can be a extrusion or stamping that the cavity is filled with a combination of materials foam, coating, Kevlar® polyurethane, or anti-ballistic gel, depending on the function of providing strength, sound dampening, strike face, decorative, etc. The fabric laminate may also be coated with various substances to help provide decorative features, or to stiffen outer layers to deform bullets, or to provide sound deadening, or otherwise provide other desirable features.

The barriers can be provided in modular sections that can deploy horizontally or vertically. The device can deploy from the top bottom or side. Sections can be provided in fabric or hinged, daisy chained, or wired together. Speakers and/or lights can be provided in various sizes. The sections can be electrostatic or the equivalent of a thin speaker to block light sound bullet etc. (as described in more detail below). The barriers can provide light or emitted sound. Barriers, such as blinds or shutters can use speakers for security, and can block light and provide sound. Speakers can be provided to vibrate the barriers do active noise cancellation. Barriers can be designed in a way to dissipate the energy from the shot through motion, destruction, heat dissipation, deformation, or other processes. They may sacrifice themselves to absorb energy much like a formula one car frame and body sacrifices itself to protect the driver.

A cavity or pockets of the barriers (e.g., blinds or shutters) can be provided to house different modules according to the needs desired or a combination of elements. Slats could rotate on there axis to displace energy or change side according to purpose. The barriers can be comprised of various layers of fabric material. The material layers may be secured to each other by stitching, quilting, gluing, welding, or merely the edges may be bound and perhaps tacked in a few spots leaving inner layers unsecured to each other, allowing motion or pockets for other uses, such as inserting materials or gels. Perhaps stitch bonding or perhaps a very open quilt pattern.

A logo can be provided, such as using 1 inch or ¾ inch binding, or by sewing in a logo. As many as 18 plies or more of woven Kevlar fabric or other material can be used in the laminated material. Fabric style can be 600d Kevlar KM2 Plus, 24×24 square yarns per inch, plain weave construction, Polyester stitching yarn, 75 denier textured yarn. Stitch pattern can be: linear chain stitch (machine direction), 3.5 gage spacing. Quilting can be used to secure the layers to each other. Layers secured only at the ends can also be utilized. It is noted that the very looseness, flexibility, and motion of the material aids in energy absorption, providing better ballistic protection and penetration avoidance. Level IIIA or better anti-ballistic protection can be achieved.

Referring back to FIG. 1, the barrier layer 110 can be fixed at one or more ends using either or both top frame component 120 and side frame components 140 to securely connect to the receptacle 150. These structures will securely brace one end of the barrier layer 110 to provide stability, with these structures in turn being braced locally using weights, guy wires, connectors, stands, mounts, or other components. The top mounting structure 120 can include features and components that retract and/or store the barrier layer 110 within the structure when retracted and/or for storage such as disclosed in a number of the parent applications in embodiments such as deployable window blinds.

In this generic approach, as discussed above, the barrier layer 110 will be a flexible layer that can move, vibrate, swing, and otherwise convert the kinetic energy of the ballistic projectile into kinetic and/or heat energy in the barrier 100 by nature of having barrier sides 112 and a barrier bottom 114 that may not be secured to any structure in this free hanging embodiment (or alternatively that could be temporarily secured to a wall or floor, respectively). The barrier can be wound on a reel or itself. A weight can be provided to the bottom frame component 130 to add mass to the barrier so that the kinetic energy of the projective is also transferred to this mass as kinetic energy by moving the mass of the end 130, which can include lifting the end, swinging the end, and other types of motion. The end 130 also helps keep the barrier 100 in place by providing stability and in a deployable embodiment, may also help deploy the barrier 100 in emergency situations, as is also discussed in the parent applications.

Note that automatic deployment, based on the detection of a dangerous situation such as an explosion or gunshot (e.g., triggered by sound waves, breaking glass, light flash, or even detection of intruders, for example) can be provided as discussed in the parent applications. Manual deployment through activation of a motor or drop function through use of a switch, lever, or other manual activator can also be provided as an alternative or supplemental means of deployment. The weight 130, when provided, can aid in quick deployment and stability. Such barriers can be provided or moved into windows, doorways, hallways, or even across rooms, for example.

Alternative approaches where the barrier is installed in a rising manner could also be provided. For example, posts may rise out of the ground or floor for deploying the barrier from the ground up, with the top portions free to move, or with sufficient flex in the barrier to allow freedom of motion. Such devices can protect hallways, stages, rooms, doorways, garage doors, or other locations in and out of buildings.

As an alternative, the side mounting structures 140 may be extended further, even along the entire length of the barrier sides 112, to secure the sides. Such structures may be mechanical rails or magnets that secure the deployed barrier on its sides. Grooves in a door frame or other structures could be used to secure the sides. Alternatively, linking edge structures can be provided that interlink when extended to add stiffness and structure to the sides of the barrier.

Furthermore, an optional floor or ground structure 152 can be provided at a bottom of the barrier 100, such as on or beneath a floor or the ground, to secure the barrier bottom 114 when deployed. For example, bottom 114 may include a magnet along it's length as part of the weight 130, and the floor structure 152 could include a magnet of an opposite pole (which may be an electromagnet), to secure the bottom 114 to the floor. Alternatively, floor structure 152 might include a latch or gripping device that secures the bottom 114 to the floor. Hence, in conjunction, extended side mounting structures 140 and/or the floor structure 152 secures the barrier 100, when deployed, to prevent individuals or objects from passing beyond the barrier 100 into a protected region.

As discussed above, the mobile device of FIG. 1 could be provided with additional components to aid in mobility, such as a frame and wheels, or structure to hand the device in a door, on a wall, or in a window using features such as shown in FIG. 2, such as brackets 320 that might be permanently or temporarily installed. The mobile device is configured to be made installable and removable so that the device can be stowed in storage when not in use.

Note that automatic deployment, based on the detection of a dangerous situation such as an explosion or gunshot (e.g., triggered by sound waves, breaking glass, light flash, or even detection of intruders, for example), or a shouted command, or speeding vehicle can be provided. Manual deployment through activation of a motor or drop function through use of a switch, lever, or other manual activator can also be provided as an alternative or supplemental means of deployment. The weight provided in bottom frame component 130, when present, can aid in quick deployment. Such barriers can be provided in windows, doorways, hallways, or even across rooms, for example.

Alternative approaches where the barrier is installed in a rising manner could also be provided. For example, posts may rise out of the ground or floor for deploying the barrier from the ground up, with the top portions free to move, or with sufficient flex in the barrier to allow freedom of motion. Such devices can protect hallways, stages, rooms, doorways, garage doors, or other locations in and out of buildings.

As discussed above, FIG. 2 shows a particular embodiment of the generic approach of FIG. 1 by providing a mobile barrier 305 with support and stowing structures 320, 315 for deploying the barrier layer 310 with weight 325 in a window or door frame. This device can be removed form the brackets 320 for stowage.

Note that barriers that are constructed of ceramic or composite ballistic material can be much lighter and cheaper to build than barriers that use metallic materials, such as steel, for example, and they could prove flexible and more deployable and retractable.

Barriers using fabric and/or panels held together by fabric that can be folded into an accordion shape can be utilized. Also having barriers in a horizontal or vertical position. Closing and opening from all possible sides can be provided, e.g., from the top or bottom or left or right. Also, a combination of these approaches can be used. Barriers could close from both sides. Or close from the top and bottom where each barriers half covers half of a particular window. Roll down fabric barriers using ballistic materials that come down from the top, or up from the bottom (or from one side or another), such as that can be quickly deployed can prove useful. Also panels that fold down from the top or up from the bottom (or from a side) can be utilized.

Ballistic resistant panels can be provided with ballistic material provided on back of an ornamental design (e.g., wooden slats), or between ornamental designs, so that the barriers provide ornamental aesthetics. The ballistic materials may be woven into a layered cloth that can be attached, glued, or otherwise combined with the ornamental panels to achieve the desired effect. A string or rope made of the ballistic material can be used to replace the string/rope that may be utilized in existing applications.

For example, FIG. 3A shows a side view of a laminated sheet 400 having ballistic layer 420 sandwiched between decorative or structural layers 410 and 430. As an example, layers 410, 430 could be a single layer of fabric surrounding a ballistic panel as layer 420. Or ballistic layer 420 might comprise a fabric woven from anti-ballistic fibers, making the entire slat of layers of fabric and/or sheets of material. Any number of a layers can be used to further strengthen and improve the anti-ballistic qualities of the sheet 400.

Alternatively, part of the barrier can be made as individual rigid components, such as louvers/slats, which can be made in this laminated manner to provide both decorative and anti-ballistic features. The layers could be stitched or glued together, or bonded in some other manner, such as by heating them to weld them together or stitching them together using a strong thread, as described hereinbelow. A lamination machine that binds the layers using heat can be used.

FIG. 3B shows an example barrier comprised of an anti-ballistic laminate 450 having a plurality of layers of flexible, anti-ballistic material 455 and a decorative (or structural) top layer 452 that are stitched together using stitching 458. An embodiment may use any number of layers of anti-ballistic material, which may be a woven cloth material or a thin sheet. For example, such a barrier might use two, or more than two such layers. In a preferred embodiment, 18 layers of level IIIA bullet proof material, such as an antiballistic cloth material or thin sheets of material as discussed above can be stacked into a laminate that can be glued, heat welded, or stitched using a thread, such as nylon, polyester, Kevlar or Dyneema® threads, to secure the layers together. The top (or even bottom) decorative layer 452 can be comprised of a decorative cloth or sheet. A binding material or strip can be put around the outer edge of the sheets or slats for decorative purposes or for physical support and further binding. For large sheets of materials, stitching will be provided at periodic intervals (e.g., 0.75 inch spacing).

For example, 18 plies of woven Kevlar fabric such as a 600d Kevlar KM2 Plus, 24×24 square yarns per inch, plain weave construction, polyester stitching yarn, 75 denier textured yarn with a stitch pattern from a linear chain stitch (machine direction), 3.5 gage spacing or 0.75 inch spacing.

Sheets of material of the barriers, or individual slats, may have the individual fabric sheets bound by using a glue or substance around a perimeter of the sheets or a pair of edges to hold the sheets together, but let the layers remain unbound in an interior portion. FIG. 3C shows a side view of an example two-layer laminate 200 with first and second fabric layer 201 having only upper and lower edges 202 bound with an edging material (such as stitching, bonding, edging, etc.) leaving an inner gap 205 formed from the loose material. Of course, any number of layers can be used in the laminate rather than just two. This approach could be designed to self-destruct in order to better absorb the energy of a projectile.

The laminated material of FIG. 3A or 3B or 3C can be formed into sheets to form large surface areas from any number of layers, or into slats to form venetian blind or shutter style barriers, or alternatively into large sheets to form solid barriers that can be used in homes or vehicles as discussed herein.

Alternatively, tensylon slats can be used for barriers, such as venetian style blinds. As an alternative, a thin layer of steel as a strike face can be provided on the slats to improve the anti-ballistic properties. Tensylon slats, with or without the steel surface layer, can slide in pockets on the Kevlar fabric blinds to add further protection, such as in solid sheets that are rolled up when retracted and unrolled when deployed, as described hereinabove. Such barriers re flexible and lightweight, and could be designed to level 4 protection to stop rifle rounds.

The barriers could be utilized in a configuration similar to that of security shutters, in at least a portion of the shutters could utilized fabric materials to better absorb energy from the projectiles such as bullets. A metallic face of the shutters could be used as a strike face to deform a bullet and then a layer of fabric material in a sheet or slats could be used to fully stop the bullet or shrapnel. Or hollow portions within various slats of the shutter could be filled with the barrier material provided in strips, for example, or filled with an anti-ballistic gel. Such shutters could be retracted by folding individual slats upon themselves, with individual slates bound by hinges or continuous portions of flexible material with the rigid slats glued or otherwise secured to the flexible sheet or hinges.

FIG. 4 shows an example of a mobile deployable barrier 600 having a base 604 having a receptacle for retracting the barrier 603 and a top frame portion 602 for holding the barrier 603 in a deployed position. Top frame portion might be held in place using a frame or other structure (not shown) attached to the base 604, with such frame or other structure being retractable or removable.

This type of barrier can be mounted on another device for ease of mobility. For example, it could be provided with wheels or mounted on a flat dolly to ease movement. It could be mounted on the bed of a truck, or on a mobile trailer. The base 604 might be weighted to give the device more stability. Stakes, guy wires, or other structures might be used to help fix the device in place once it is moved to the desired location.

FIG. 5 shows another example mobile deployable barrier 610 with an upper frame portion 612 held in place using structure 611 that is connected to the base 614 via structure provided behind the barrier 613 and not shown. A stand 616 is provided to hold the barrier in place. The stand can be a collapsible tripod-type stand, as shown, or a heavy weighted stand to give stability. The stand might utilizes wheels to make mobility easier, especially if the stand is weighted. Additional structure can be provided to secure the barrier 610 in the chosen location, and the barrier 610 can be retracted for stowage.

When fully retracted, the devices of FIGS. 4 5 basically encompasses the dimensions of the base 406/614, making them compact and mobile and easy to store until needed. Either might be carried into place, wheeled into place (particularly if weighted), or transported by a trailer or vehicle. Either could be permanently mounted on a trailer that can be towed or pulled into the desired position.

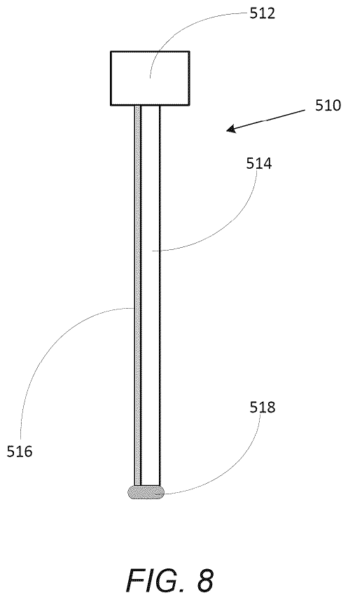

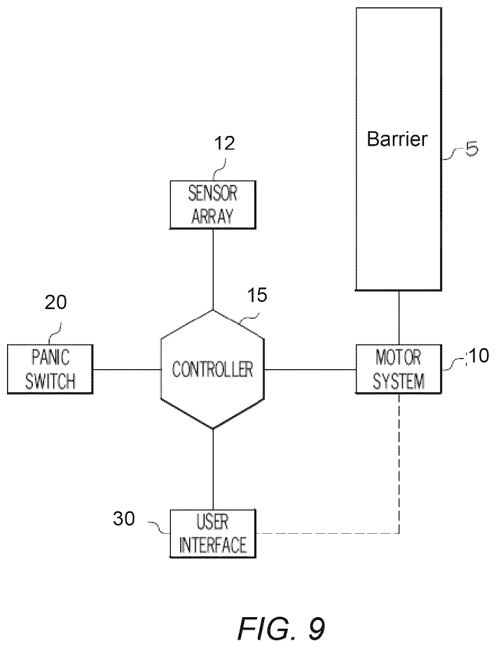

FIGS. 6, 7 show an example embodiment of a barrier device 620 having a collapsible frame 627 and a base 626 for holding the ballistic barrier 623 in a deployed position. The frame 627 and base 626 might be configured to receive air for inflating the frame components when deployed through use of a blower or other inflating device, such as pressurized air or CO₂ canister, for example. Such a device could be deployed outside, or inside a building.

The collapsible frame 627 could be constructed of a plastic or air-tight cloth material that can be inflated to for a structurally sound frame for holding the ballistic barrier 623 in a secure and stable manner for protecting against ballistic projectiles. The frame could also utilize the anti-ballistic laminates described herein to add strength and anti-ballistic properties. Frames of a design similar to those used, for example, for outdoor projector screens for showing movies, etc. can be utilized, likely re-enforced for strength and stability “under fire.”

The ballistic barrier 623 can be permanently secured to the frame 627 by using a glue or other securing method, or the barrier 623 may be removable to be rolled up when stowed, but temporarily attached to the frame 627 in a removable manner when the frame is deployed. For example, the frame 627 can be provided with hooks or latches to engage reinforced holes or loops or corresponding hooks provided on the barrier 623, or magnets might be used, or Velcro (hook and loops), for example. The ballistic barrier 623 can be comprised of any of the anti-ballistic laminates described herein, for example.

Alternatively, the frame components might be made of a metal or non-metallic materials, such as PVC components (e.g., pipes) that can be assembled and disassembled, or made of an antiballistic material as disclosed herein, or a rubber or plastic material. The frame components might be solid, or comprised of a chain or rope or twine including anti-ballistic materials as disclosed herein. This frame can be made of woven lightweight anti-ballistic materials as discussed herein, or metallic materials could be used. PVC pipes can be removably assembled having a tight fit.

Similarly, the barrier embodiment 621 shown in FIG. 7 can be provided where the barrier 620 is provided with guy wires 629 to better secure the barrier 121 in place. Alternatively or in conjunction, various ground securing devices could be utilized, such as posts that can be pounded into the ground, or weights on the base of the frame, or magnets, or guy wires, or various types of braces. Furthermore, means of attaching the barrier device to structures such as buildings, fences, etc. can be useful. Furthermore, the base 626 could be secured to the ground or a floor using other structures. Such a device can be provided with sufficient structure, strength, and stiffness in order to utilize the anti-ballistic barrier 623 stop large, moving objects such as vehicles or large pieces of shrapnel, thrown objects, objects fired using a mortar or other launching device (e.g., tear gas canisters), etc., as well as bullets fired from guns.

When retracted, barriers 620 or 621 can be collapsed into a compact form to be stowed in storage for future deployment and use. For example, when fully retracted/deflated, the device of FIGS. 6, 7 can be collapsed into a compact form, making them compact and mobile and easy to store until needed. The device might be carried into place, wheeled into place (particularly if weighted), or transported by a trailer or vehicle. It could be permanently mounted on a trailer or flat dolly that can be towed or pulled into the desired position.

A netting or mesh woven material can be used for the barrier layer that is comprised of the strong, light-weight anti-ballistic material disclosed herein, either formed into solid strands or woven as a rope or twine material to form a mesh having any desired gauge and gap size between strands. Solid woven materials that are flexible and lightweight can be used. Reinforcing cables or ropes or chains or bars can be provided entwined or attached to the material to strengthen the overall barrier. Such reinforcing structures can be made of woven lightweight anti-ballistic materials as discussed herein, or metallic materials could be used.

Such a barriers can be used in a doorway, hallway, window frame, around an office or cubical, or around a building or vehicle or pedestrian entrance, for example, to stop various projectiles, shrapnel, people, etc. from entering the interior of the building or the protected space(s). They can be deployed using compressed gas (e.g., in a gas cylinder), or filling with air using a pump or fan.

Any of the above barrier designs can be made more easily mobile by mounting the barrier on a trailer or dolly. FIG. 12 shows a general design for a dolly or trailer 910 that can be used to transport a retracted and collapsed barrier 900 (which can be any of the above barriers), having a storage structure 901 for storing the retracted ballistic barrier, and another structure 905 (such as a frame or bar or other structure discussed hereinabove) for aid in deploying and the ballistic barrier and keeping it deployed. The dolly/trailer will have a base or bed 910 upon which the barrier 900 can be mounted. The base/bed 910 has wheels 912, and may have added mass and weight to give the barrier more stability if the barrier will be deployed on the dolly/trailer. A handle or hitch 914 can be provided for pulling the entire package. When to be deployed in conjunction with the dolly/trailer, the barrier 900 may be permanently mounted on the dolly/trailer.

Any of these mobile barriers might be temporarily installed on, or adjacent to, an interior of a door, garage door, deployable shutter system, over glass, deployable blinds, etc. in a temporary manner. The barrier(s) might be installed in an interior of such items as well. The barrier(s) might be made sufficiently transparent to be installed over or on or adjacent to windows in either a deployable, or a permanent manner. Alternatively, the barrier(s) might be deployed in hallways, entryways, as room dividers, etc., allowing deployment during emergency situations to provide ballistic protection and barriers. These barriers can be deployed to protect parks, stadiums, atriums, yards, courtyards, and other spaces inside or outside of buildings. They can be deployed as part of fencing to keep threats out of protected areas. But in all cases, the barrier can be retracted to be compacted and stowed and moved to a storage location when not in use, to be later deployed in any desired location to provide the desired protection.

Doorways or other egress/ingress or pathway locations for vehicles or personnel can also be protected using barriers that operate in a fast deployment and fast retracting embodiment, some of which involve a shutter-like design with slats, rods, or bars that roll up, fold, or into a spiral on a retraction roll that is motorized for quick deployment and retraction. Again removable mass can be provided to provide structure and stability. Rather than, or in addition to, slats, a flexible fabric or other material, such as the anti-ballistic materials described herein, can be utilized for the barrier. The barrier, which would be made with a flexible barrier layer (screen) to allow it to roll or fold to retract and deploy, can be provided.

The barrier could be flexible enough to allow retraction and compaction, such as by making the main portion of flexible anti-ballistic sheets or mesh or netting, and making any frame retractable or configured to be disassembled. Fireproof materials can be provided to add fire resistance to the door, and insulation can be added to protect an interior from heat of fire, for example. For example, a silica layer, silica sheet, silica cloth, or other surface treatment could be provided to add fire and heat resistance, as can other materials such as fiberglass, asbestos, etc.

Such a barrier can be utilized to protect against ballistic objects, as discussed regarding the disclosed designs in the cited references, all incorporated herein. Hence, such barriers can be provided in hallways to wall-off portions of interior buildings or protect those interiors from external access, providing barriers against intruders whether on a vehicle or not, and to protect against ballistic projectiles such as bullets, arrows, rockets, shells, or shrapnel from explosions. By providing fire resistance, the barriers can also protect against the spread of fire and its resulting heat. The barriers can also protect against explosions and ballistic projectiles like bullets, shrapnel, etc.

As discussed for blinds or door designs in the referenced applications, such barriers might automatically deploy upon detection of heat, an explosion, gunfire, or another alarm condition that might be automatically detected or manually activated. Emergency responders also might deploy the systems, as might burglar alarms, fire protection systems, etc.

Other options for use of such barriers in vehicle door panels and other hollow bodies include inflatable bags that can fill with an anti-ballistic gel, sand, balls or other material to provide anti-ballistic protection. Airbag type devices might also be provided that deploy outside of the body panels to protect individuals inside the vehicle, where such airbags might be comprised of anti-ballistic inflatable sheets as discussed herein or filled with anti-ballistic material such as a gel. Such systems may be automatically or manually deployed, or permanently deployed, all of which is discussed herein and in the parent applications for various barrier embodiments. An automated piloting system might be automatically activated upon deployment of the barrier, such as might be found on a land vehicle or aircraft. Alternatively, displays can be used to show the environment external to the protected space.

Such a door barrier can be made sufficiently strong to stop a speeding vehicle. If the door is designed to flex and stretch, it can absorb much of the kinetic energy of moving objects without breaking, protecting an interior space and avoiding penetration by the undesirable object.

Furthermore, existing doors can be outfitted (retrofitted) with an added layer of material as disclosed hereinabove, such as by providing the ropes and/or layers of netting or other forms of the lightweight anti-ballistic material to add additional structure and energy absorption capability to an existing door. In such a situation, the retrofit barrier might be attached to the door using a glue, welding, mechanical fastener, Velcro, or other means of fastening the barrier to an existing door. Such a retrofit would allow the door to continue to be retracted or opened in the original manner.

In particular, a mobile, deployable barrier system using any of the above approaches is desired that can stop objects of substantial mass from penetrating the barrier and entering the protected space. Objects of substantial mass on the order of pounds, tens of pounds, hundreds of pounds, and thousands of pounds are contemplated to be protected against. For example, protecting against thrown objects like large rocks, bricks, liquid or solid filled bottles, rockets, missiles, mortar rounds, drones (such as drone vehicles), personnel vehicles of any size or weight, running individuals, battering rams, etc. Barriers that protect against one or more of these types of objects using strong, lightweight anti-ballistic materials is desired.

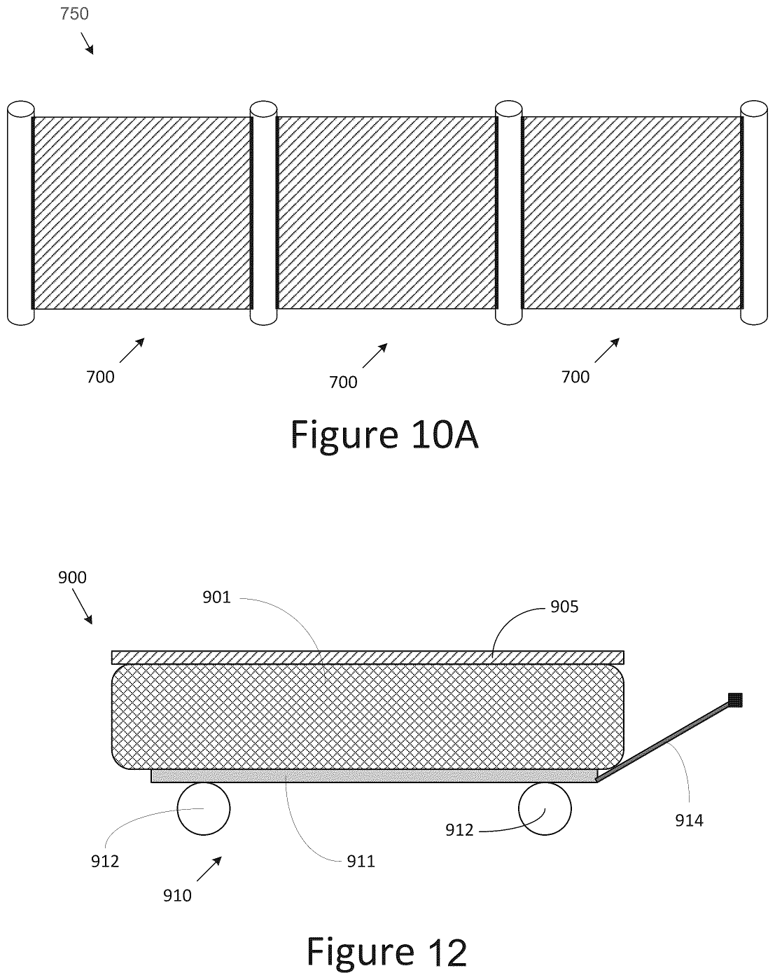

An alternative embodiment of a mobile protective structure is a fence system comprised of a plurality of fence sections, each of which comprise a ballistic protective panel comprised of a substance as discussed herein. FIG. 10 shows an example fence section 700 comprised of an antiballistic barrier 710 formed of an antiballistic material (such as a laminate or panel as discussed herein) and at least one post 720 having a slot 730 provided therein. The slot 730 can be a slot in which the edge of the antiballistic barrier (which might include a bar or other structure corresponding to the dimensions of the slot) 710 is slid in and out, such that the antiballistic barrier 710 is a panel that might be flexible or even stiff, such as utilizing any of the barrier layers described herein.

Alternatively, the post 720 can be hollow such that the antiballistic barrier can be stowed within the post by rolling it up using spring mechanism (as discussed hereinabove for various barrier designs). Then, the edge of the barrier of one fence section 700 can be connected to an edge of an adjacent fence section 700. These connections might be by sliding a stiff part on the edge of the barrier 710 (such as a rod or bar) into a slot on the adjacent fence section, much the way guides used to form lines for people use cloth tape/strips wound in poles. Alternatively, strong magnets could be used to connect the edge of the barrier of one fence section 700 to the pole of an adjacent fence section 700.

For example, FIG. 10A shows a series of fence sections 700 placed adjacent to each other (in series) to form a longer fence. These sections can be placed at angles to one another to form any shape. Any number of these fence sections 700 could be strung together to form a fence of any length and shape.

An alternative approach would be to have the antiballistic section 710 be comprised of a flexible antiballistic material as described herein that might be coiled around the post section 720 when in a retracted position and unrolled when deployed.

Another alternative approach is that the post section 720 is hollow and can hold the antiballistic section 710 within the post section 720 is a rolled or coiled fashion such as using a spring wound approach like the device of FIGS. 4 & 5, or a manually wound approach, such as by using a lever to wind up the antiballistic section into the post section. . . . The antiballistic section 710 can then be pulled out from the post section 720 and fastened via a slot 730 to an adjacent post section 720. In this way, similar to the above embodiment, a fence of any desired length can be created by daisy chaining the individual sections together. Again, stacking sections on top of each other can provide a potential fence of any desired height.

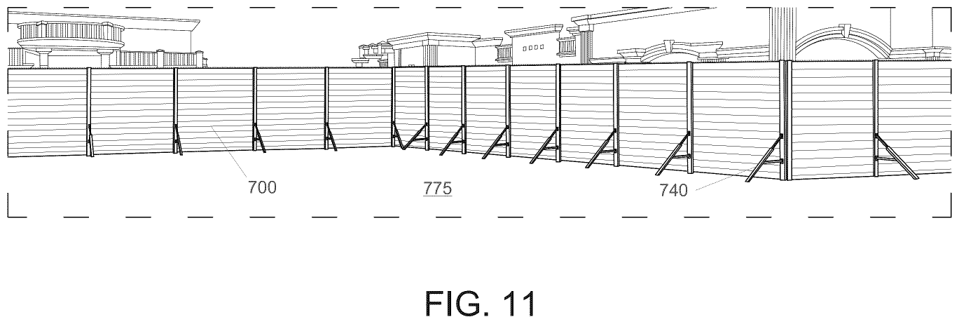

For an example system, a plurality of relatively stiff or flexible fence sections 700 could be used adjacent to each other to create a fence system to protect a space. In this case, the post 720 might have a plurality of slots 730 any of which could receive an antiballistic barrier 710 such as shown in FIG. 10A. If the posts of the fence sections are made stackable, where one post would be physically connected to a post underneath to form a structure capable of withstanding forces, a fence of any desired height could also be created. By daisy-chaining a plurality of sections 700, a fence of any length could be created, such as shown in FIG. 11, to protect an area 775. The fence can be strengthened using various bracing structures 740 such as those shown in FIG. 11.

Note that this fencing system could be designed to attach to existing structures for strength and stability. For example, existing fences, gates, statues, barriers, and/or buildings could be utilized. Also, the fence sections could be modified to attach to existing mobile protective barriers like gates used to separate people from protected regions. Straps, latches, ropes, or other mechanisms can be used for such attachments.

A fence using stiff ballistic barrier sections could be easily transportable by stacking stiff sections on top of each other, and using a plurality of posts that can be made of minimum thickness for ease of transport. Where the barrier is flexible and stowed within the posts, transportation is even easier as the posts merely need to be transported, such as by using a trailer or truck bed.

In either of these embodiments, using an antiballistic section comprised of a barrier layer such as described herein, which can be made flexible, or as stiff as desired by use of a stiffening substrate (that might also be comprised of an anti-ballistic material as described herein), or by increasing the number of layers of the substrate, will provide substantial anti-ballistic protection in a portable and configurable system. These fences can be used inside a building in open areas, or around structures or to provide protective spaces in open areas, as desired.

These fence sections are preferably of a height that at least can protect persons positioned behind them (e.g., 5, 6, or more feet tall, or stackable to such heights), and potential lengths of 4 or more feet. Longer is preferable to make assembly of the fences less time consuming, but of course the length must be balanced with the maximum weight limit. It is preferable that individual fence sections or parts be movable by one or two persons, hence in the range of 50 to 100 lbs. or so each, which will limit the length of the barriers. Heavier or lighter solutions could be used where desired, however.

FIG. 8 shows another alternative embodiment, where a mobile display barrier system 500 is provided with a barrier system 510 and an integrated display 516 integrated with the deployable barrier system 510 to provide the display material, such as described for use with a projector system. The barrier system 510 can be any of a number of barrier systems already proposed, but in this example a drop-down barrier 514 (such as the flexible laminated barrier discussed hereinabove and/or in the related applications) is deployed from a mobile deploying and retracting structure 512. An optional weight 518 is provided to add mass to the system and aid in deployment. The barrier system 510 is provided with an integrated display surface 516 which may include a flexible LCD screen that is laminated or otherwise mounted on the barrier 514 and which can be “rolled up” with the barrier 514 for retraction within the structure 512. The display surface 516 might be used with a projector system. This display surface 516 is sufficiently flexible to retract with the barrier 514 into the mounting and retracting structure 512, which would include the display electronics to drive the display 516.

This system of FIG. 8 can display any desired information including safety and/or deployment information, but provides the added benefit of not needed an external projector to be installed, and also provides the other benefits of a self-contained display. Where necessary, this display may have backlights or externally projected lights to support the displayed image. Alternatively, other technologies other than typical LCD displays might be used, such as organic LED, traditional LED, plasma phosphors, or other display technologies can be utilized with their respective benefits.

Another alternative is to use a separate display for showing the external environment. Such a display might be added to the protected space, or it might already be present, such as on a navigation or other video system (such as a backup video system on a land vehicle, or a heads-up display on an aircraft).

Any of these embodiments of a deployable barrier with display capability could be used in any of the applications disclosed herein or in the related applications.

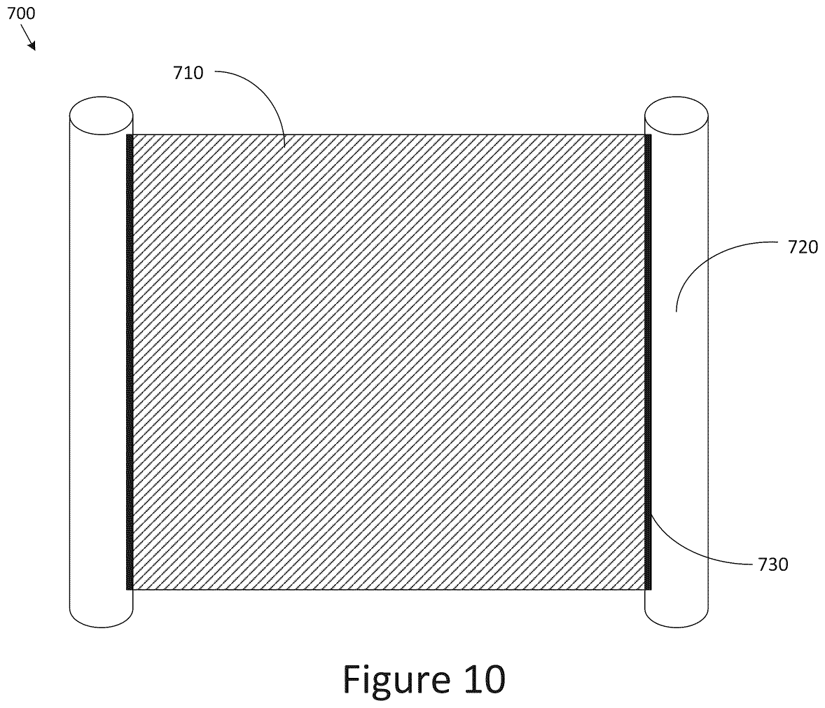

FIG. 9. Illustrates an example of a control system which may be used by any of the embodiments described herein to control the barrier system 5. The control system can include a controller 15 with one or more sensors that form a sensor array 12 connected to the controller 15, and a panic switch 20 connected to the controller 15. The sensors may be pre-existing sensors in a home defense system or conventional after-market sensors capable of detecting ballistic signals such as sound (e.g., gun shots or breaking glass), gun powder, gun impact, muzzle flash, temperature, and the like. The sensors could be any of those typically used to detect a break in, for example. The controller 15 is connected to a user interface 30 whereby a user may activate and apply settings to the barrier system. The controller 15 is also connected to a motor system 10 for actuating the barrier system upon receiving information indicating that a threat is present and that the barrier should be deployed (i.e., put into a protective state such as a ballistic protection mode).

Where a building may already have a central control system (e.g., a security or other alarm system), controller 15 may utilize such a system by adding additional customized code for operating the barrier system 5. In another example, the barrier system could also utilize ground sourced radar, infrared (heat), sonar, or some other active or passive detection system. The sensor array 12 can include one or more heat sensors, infrared sensors, video sensors, audio sensors, smoke detectors, or other types of sensors, or may utilize already existing sensors of a fire or burglar system, for example. Any of the sensors in the sensor array 12, the panic switch 20 or the user interface 30, or any combination of these components, may be connected to the controller 15 in a wireless manner, such as by Wi-Fi or Bluetooth, for example, and the panic switch and/or user interface could be implemented on a cell phone or tablet computer, for example.

The system or any of its components may be controlled by any external or internal system, such as one that may exist prior to the installation of the barrier(s). For example, the barrier system could be tied to an external system such as an alarm system or video cameras with analytics. The barrier system could also be controlled remotely via the internet or a Wi-Fi or Bluetooth connection by any connected device such as a tablet, computer, PDA, or a smartphone. Barriers such as disclosed herein would be very useful in a panic situation in a school or federal building. Such barriers could also be used in a lock down situation to prevent people or valuables from leaving the premises, for example. FIG. 9, described below, shows an example embodiment of a remotely controllable system.

Alternatively, other devices that are actively “listening” to ambient noises or “watching” for activities could be used as sensors to monitor for sounds that indicate a location is under attack for communication to a control system. Sounds such as explosions or gunshots, smoke (and other gunfire or explosive products), breaking glass, explosions, or voice command (e.g., “deploy barrier” or “deploy blinds”), to deploy the barrier or blinds. For example, the Amazon Echo device (or the similar Echo Dot, Echo Show, Echo Plus, Echo Spot, Echo Auto, Fire Devices, among other devices), using the Alexa application (or a related application, such as the Amazon Alexa Guard app), can actively listen to ambient room noise, and could be utilized to monitor for such emergency sounds and then respond by actively deploying the barriers, using Alexa's automation applications. These devices have Bluetooth connectivity, and connect to such other monitoring devices as video cameras (e.g., Blink), and video doorbells (Ring), etc., which permit active networking of devices to respond in concert to any detected threat by audio, or, when using video devices, by video (such as detecting a person holding a gun or other weapon, etc.).

By using Alexa or similar devices and application in numerous locations, courtyards, parks, or interiors, one can pinpoint the location of the shooter. For example if there is a courtyard with surrounding classrooms, a shooter could be monitored and followed. Or in a residential community with multiple residences or in a city with multiple offices and buildings all the Alexa devices can share information such as gunshot glass breakage smoke heat etc. To help authorities or building systems pinpoint the location of threats to take offensive defensive measures. The system could also change colors and flash so the fire department or police could have visual alerts. These audio or visual alerts could also guide the children or office worker where to go to evade the assailants. By sharing information between multiple integrated systems, problems can be detected and actions can be taken. Lights doors ventilation etc.

Alexa can also be used in utility rooms and data centers for predictive maintenance when heat sound or light than corresponds to various problems. For example a heat exchanger fan motor could be replaced based on the change in sound or temperature. Alexa could also take weather into account to control various systems and predict outages for as simple as replacing lights.

Similar devices such as Google's Home devices (e.g., Home Mini, Big Home Max, Home Hub), Apple HomePod, Harman-Kardon Allure and Invoke, Lenovo Smart Display, Triby Smart Speaker, Mycroft Mark 1, JBL Link View Smart Speaker, Sonos One, among others, along with the Apple Siri app and the Windows Cortana. Any of these systems and/or applications could be adapted in a similar manner as discussed above with respect to the Alexa devices.

Such systems could also be utilized to deploy burglar defense systems such as disclosed in U.S. Pat. No. 10,229,569 filed on Mar. 14, 2014, and incorporated herein by reference, that deploy anti-burglar substances such as pepper spray.

The barriers could be retrofitted to an existing building or other structure, and adapted to tap into existing security or burglar alarm systems, for example, or they could be added during structure construction. The mobile barriers can be deployed in a retracted position, only to be automatically deployed based on instructions from the control system. Such systems would utilize motors or other deployment devices as part of their mobile devices for such automatic deployment.

The barriers could also be adapted to sense the location of the occupants of the building and close by according to predetermined parameters such as direction of threat and the location inside the building that would be the best to return fire from. barriers could also be controlled by facial recognition, video analytics, or by the occupants' voice or any other suitable biometrics, such as for recognizing an threatening person, such as an ex-spouse, or ex-employee who has made threats or acted in a threatening manner, or otherwise recognizing a wanted criminal or an enemy soldier, for example. When the barrier system 5 is activated, the barrier may deploy as discussed above so as deflect bullets, shells, or other ballistic weapons to prevent a fatal impact and/or property damage. Such barriers can protect from thrown objects as well, such as rocks, grenades, bricks, Molotov cocktails, etc. Barriers could be controlled individually or together with a timing mechanism.

The barriers could be configured to protect against remote monitoring of sound and conversation, such as by providing random vibrations to the barrier to avoid vibration detection by remote monitoring devices, for example.

As an example use, the barrier system may be provided in an open state where the barriers are provided in an retracted condition to allow viewing or travel through the barriers, or the barriers in a retracted position. The barrier system sensor array would detect a potential intruder or the sound of gunfire using visual, auditory, or other sensed information. The system would then automatically enter a protective state, such as by deploying the barrier (by lowering it to protect a space), or both, to protect the interior of the room from external entry of projectiles (e.g., bullets), for example. Or the system may detect the entry of a ballistic projectile (e.g., a bullet, rock, etc.), or threatening shouts or yells, sirens, explosions, proximity of threatening individuals, etc., in which case the barrier would be activated into a protective mode.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

1. A mobile device configured to protect a space from ballistic objects, comprising:
a flexible deployable barrier comprising a flexible anti-ballistic material that can be retracted and deployed; and
a deployment structure configured to hold said deployable barrier in the deployed position, wherein
when in a deployed position, said deployment structure is configured to keep said deployable barrier in the deployed position while engaging ballistic projectiles impinging upon said deployed barrier from outside said space to protect said space, and wherein
when said deployable barrier is in a retracted position, said mobile deployable barrier is configured to be mobile.

2. The mobile device of claim 1, further including a storing structure as part of said deployment structure, said storing structure being configured to store at least a portion of the deployable barrier in a retracted position in a rolled or folded state;

3. The mobile device of claim 1, said deployment structure further comprising a frame for providing structural support to the deployable barrier.

4. The mobile device of claim 3, further comprising a base connected to said frame, said base providing a stable platform for the mobile device on a surface.

5. The mobile device of claim 4, wherein said base is collapsible.

6. The mobile device of claim 2, wherein said mobile device is configured to form a barrier fence by placing a plurality of mobile devices adjacent to each other in a series with said deployable barrier deployed to form said fence.

7. The mobile device of claim 6, wherein said storing structure is configured as a hollow pole which can receive said deployable barrier rolled within the pole for the retracted position.

8. The mobile device of claim 7, wherein the deployable barrier of one mobile device is configured to engage the pole of an adjacent mobile device to form said fence.

9. The mobile device of claim 8, wherein the deployable barrier of one mobile device is configured to engage the pole of an adjacent mobile device using a slot structure configured with the pole of the adjacent mobile device.

10. The mobile device of claim 8, wherein the deployable barrier of one mobile device is configured to engage the pole of an adjacent mobile device using a magnet.

11. The mobile device of claim 7, wherein when retracted, said mobile device has dimensions substantially the same as said pole.

12. The mobile device of claim 6, wherein one mobile device can be stacked on top of another mobile device to increase the height of the fence.

13. The mobile device of claim 1, wherein said deployment structure is configured to be inflated with a gas to deploy said deployable barrier.

14. The mobile device of claim 13, wherein said mobile barrier is retracted by venting said gas

15. The mobile device of claim 13, wherein said mobile barrier is permanently mounted on said deployment structure in a collapsible manner to form a mobile package when retracted.

16. The mobile device of claim 13, further comprising a gas canister including a compressed gas for providing said gas for deploying said barrier.

17. The mobile device of claim 13, wherein said mobile barrier is removable mounted on said deployment structure and which is configured to be rolled into a roll or folded when retracted for stowage.

18. The mobile device of claim 17, wherein said mobile barrier is configured to attach to said deployment structure using magnets or hook and loop fasteners.

19. The mobile device of claim 1, wherein said deployable barrier is comprised of a plurality of layers of anti-ballistic material formed into a laminate.

20. The mobile device of claim 19, wherein said laminate is formed by gluing or stitching said layers together.

21. The mobile device of claim 19, wherein said laminate is formed from three or more of said layers.

22. The mobile device of claim 19, wherein each one of said layers is formed by weaving threads or fibers of an anti-ballistic material into an anti-ballistic cloth to form said layers.

23. The mobile device of claim 22, wherein said anti-ballistic material is comprised of a high tensile strength synthetic material.

24. The mobile device of claim 22, wherein said anti-ballistic material is comprised of Kevlar, Lexan, Dyneema, Tensylon, or Lucite.

25. The mobile device of claim 19, wherein said anti-ballistic material is comprised of a high tensile strength synthetic material.

26. The mobile device of claim 19, wherein said anti-ballistic material is comprised of Kevlar, Lexan, Dyneema, Tensylon, or Lucite.

27. The mobile device of claim 19, wherein said anti-ballistic material is configured to be fire resistant.

28. The mobile device of claim 19, wherein said anti-ballistic material is configured to stop certain bullets fired from a firearm.

29. A method of protecting a space from ballistic projectiles, said method comprising the step of:
providing a mobile device comprising a deployment structure, a storage structure, and a deployable barrier including a flexible anti-ballistic material that can be retracted and deployed for mobility and storage, wherein said deployment structure is configured to hold said deployable barrier in a deployed position in conjunction with said storing structure for protecting said space;
storing said mobile device in a storage location until needed for deployment;
moving said mobile device to said space; and
deploying said deployable barrier to protect said space from said ballistic projectiles.

30-39. (canceled)

40. The method of claim 29, wherein said deployment structure is configured to form a shelter when deployed for protecting said space that is inside said shelter.

41. The device of claim 1, wherein said deployment structure is configured to form a shelter when deployed for protecting said space that is inside said shelter.

42. A mobile device configured to protect a space from ballistic objects, comprising:
a flexible deployable barrier comprising a laminate of a plurality of layers of a flexible anti-ballistic material that can be retracted and deployed;
a storage structure for storing said flexible deployable barrier in a stowed condition; and
a deployment structure configured to hold said deployable barrier in the deployed position, wherein
when in a deployed position, said deployment structure is configured to keep said deployable barrier in the deployed position while engaging ballistic projectiles impinging upon said deployed barrier from outside said space to protect said space, and wherein
when said deployable barrier is in a retracted position, said mobile deployable barrier is configured to be mobile.
